(19) United States
(12) Patent Application Publication
(10) Pub. No.: US 2004/0049784 A1
(43) Pub. Date: Mar. 11, 2004

(54) Method and apparatus for scrolling television programming data on screen during program viewing

(75) Inventor: Richard Stephen Grzeczkowski, Warrington, PA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/236,663

(22) Filed: Sep. 6, 2002

(51) Int. Cl. G06F 3/00; H04N 5/445; G06F 13/00

(52) U.S. Cl. 725/46; 348/563; 725/39; 725/50; 725/51

(57) ABSTRACT

A method for providing programming information available on a broadcast television service displays the programming information in a “stock ticker” format. The set-top box interacts with a user to obtain user preferences regarding the scrolling programming guide and stores the user preferences as a user profile in a set-top box that is coupled to a television display. A programming information server is accessed over a communication link between the set-top box and the programming information server to obtain programming information. The scrolling programming guide is created based on the stored user profile and overlaid on the television screen when activated by the user, preferably in an unobtrusive location, such as the lower portion of the television display.

### STATEMENT OF RELATED APPLICATION

This application is related to co-pending U.S. patent application Ser. No. ______ [Attorney Docket D2808], entitled “Method and Apparatus For Delivering Personalized Alerts To Set Top Box Users Without User Intervention,” filed on even date herewith.

### FIELD OF THE INVENTION

The present invention is directed to methods and apparatuses for interacting with a television viewer, and more particularly to a method and apparatus for interacting with a television viewer to provide television-programming information to the viewer.

### BACKGROUND

Many techniques exist for providing television programming to a viewer. Some of these techniques include providing dedicated channels to which a viewer may tune to view programming schedules. This reduces the number of significant revenue producing channels, albeit sometimes a modest amount of revenue can be sometimes generated from these channels from advertising on these channels.

Moreover, today's viewers prefer to switch channels frequently and “surf” among favorite channels, particularly during airing of commercials. As such, viewers are frequently interested in the programming that is being offered on other channels while they are currently viewing a particular channel. Currently, these viewers must tune to the programming schedule channel to determine this information. Even if the viewer tunes to this channel, the information being sought may not be available to the viewer for some time, depending upon where in the scrolling of the programming information the desired channel lies.

The present invention is therefore directed to the problem of developing a method and apparatus for enabling a television viewer to obtain programming information without interrupting viewing of a channel to which the viewer is currently tuned, which methods and apparatuses are more conducive to current viewing patterns.

### SUMMARY OF THE INVENTION

The present invention solves these and other problems by providing inter alia a method and apparatus for scrolling television-programming information on a particular portion of the television screen overlaid on the existing display, thereby enabling viewers to continually scan the programming information for items of interest without interrupting viewing of an existing channels or requiring tuning to a different channel. Moreover, the present invention enables the viewer to surf channels and still view the programming information, as the scrolling data is independent of the viewing channel or channels. So even in a split-screen type mode available on certain televisions, the viewer can still view programming information.

According to one aspect of the present invention, the television programming information is overlaid and scrolled across the bottom of the screen.

### BRIEF DESCRIPTION OF THE DRAWINGS

FIG. 1 depicts an exemplary embodiment of an apparatus for providing programming information to a user via a set top box according to one aspect of the present invention.

FIG. 2 depicts an exemplary embodiment of a display screen in which programming information is scrolled along the bottom of the display overlaid on the existing display according to another aspect of the present invention.

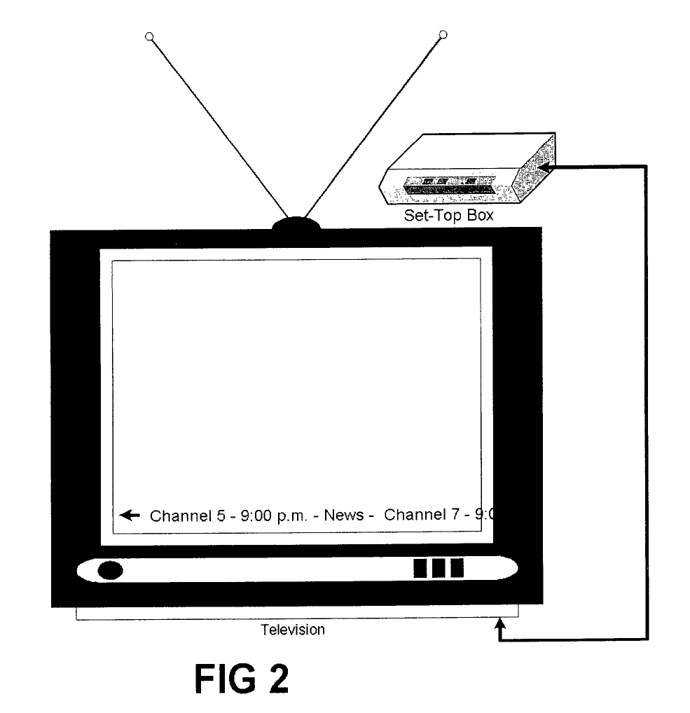

FIG. 3 depicts an exemplary embodiment of a method for creating a scrolling ticker according to another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

According to one aspect of the present invention, a viewer can select a television programming guide data ticker, which provides programming information on user specified channels in a “stock ticker” format. As used herein, a user can be either a television viewer or operator of the set top box. This television guide ticker would scroll through a predetermined or pre-selectable amount of present/future programming. For example, the ticker would scroll through the next hours worth of programming information on the available channels, or the user's selected or subscribed channels on a particular segment of the screen.

Some possible locations of the screen include the lower section, the upper section, and a vertical segment on either side of the screen. The streaming segment would be sufficiently small to avoid obstructing the current programming but also sufficiently large to be viewed across a room. As room sizes vary, the text would be viewable to about 6-8 feet away from the screen. Programming information would continue to be scrolled until shut off by the user. As such, data would be persistent across channel changes. Users would have the ability to view all data or to customize a favorites list, which if enabled, would only display programming from those selected channels in the favorites list.

Textual advertising could be inserted between listings or at the end of a segment, along with customer service announcements. This feature has the potential of being a revenue generator for MSO's through the realized advertising revenues. In addition to potentially freeing up one channel for high revenue generation programming, the present invention can provide increased revenue from advertising on the scrolling programming information ticker.

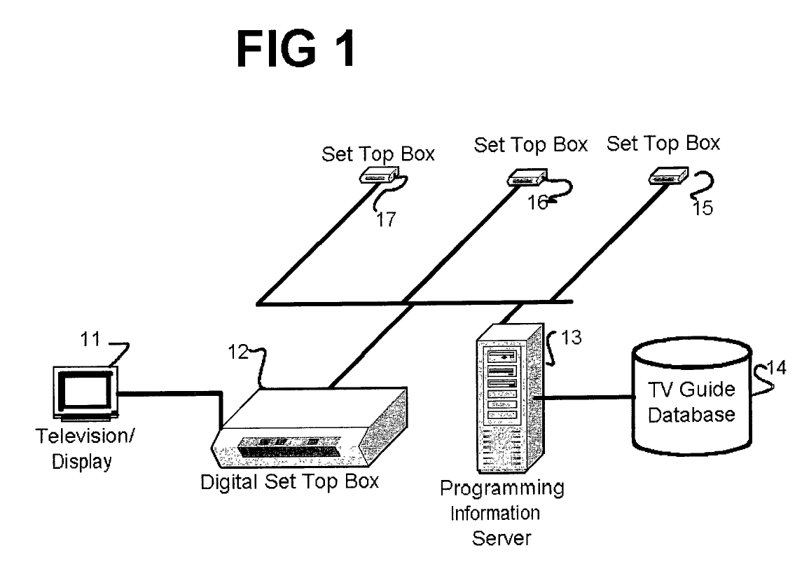

Turning to FIG. 1, shown therein is an exemplary embodiment of an apparatus 10 for providing television guide information to a user of a set top box 12. In this case, the user's set top box 12 is coupled to a cable plant 18; however, another type of communications system could be employed, such as a satellite communications system. Other users are simultaneously coupled to the cable plant 12 via their set top boxes 15, 16, 17.

An exemplary embodiment of a set top box is Motorola's DCT2000 and subsequent versions. This set top box is capable of interacting with the user by displaying an electronic programming guide, a page of which could display programming information selections, via which the user could control the scrolling display. For example, the user could select the channels, channel categories, or other subcategories of the entire television channel database that would be displayed on the lower portion of the screen. In addition, the user may be able to specify the speed of the scrolling display to his or her reading capabilities. Furthermore, the user could have preferences set for more than one user, such as a parent, child, or multiple users. This set top box is capable of displaying menu items and displaying subsequent menus when selected by a user. Moreover, this set top box is capable of receiving user selections of listed items and storing them in a memory. These features can be used to control the display of programming information.

Each set top box has a television or monitor, such as television/display 11, coupled to it. Set top box generated information can be viewed on this television or monitor. Additionally, more advanced set-tops, such as the Motorola DCT5100 could convey the beginning or end or some other significant event in the scrolling display to the user by way of audio in addition to visual display to the television or monitor.

The set top box includes a processor (not shown) that interacts with the user via the display 11 to obtain the user selections, which is used to filter the programming information retrieved from the television guide database 14 as will be discussed below. The processor, the display, a remote control, or keyboard and related programming constitute a graphical user interface via which a user can select from several possible television channels, categories or other filters suitable to control the scrolling display. For example, the user could specify that the scrolling display only display sports, movies, news and/or similar categories of programming independent of the particular channel.

A server 13, to which is coupled a television guide database 14, is also coupled to the cable plant 12. The server 13 is a standard Internet type server that provides Internet Protocol communications between a standard communications processor located in the set top box 12, via which communications the server 13 provides programming information to each set top box that is used to create the scrolling display in conjunction with the users' personal settings. Alternatively, the communication to the set top may be a hybrid form of Internet Protocol and any of several other protocols or formats. Additionally, there may be additional equipment between the server and the set top used to process and deliver the data.

The database 14 is a standard database that can be queried with a user's profile and output entries in the database 14 that match the query. The database entries include television programming guide information along with certain identifiers, such as category, type and other meta data. Any information related to each entry can be uploaded to the server 13, formatted in a message to the user and transmitted to the user's set top box 12, 15-17 over the cable plant 18.

In addition, by placing the creation of the scrolling ticker inside the set-top box, the present invention provides the capability of permitting the user to control the viewing of the scrolling ticker to modify such parameters as scrolling speed, ticker size, font, color, location, content, etc. Moreover, the scrolling ticker could also include personal information alerts as set forth in U.S. patent application Ser. No. ______ [attorney docket no. D2808], of which the current inventor is one of the co-inventors. This patent application is hereby incorporated by reference as if repeated herein in its entirety, including the drawings.

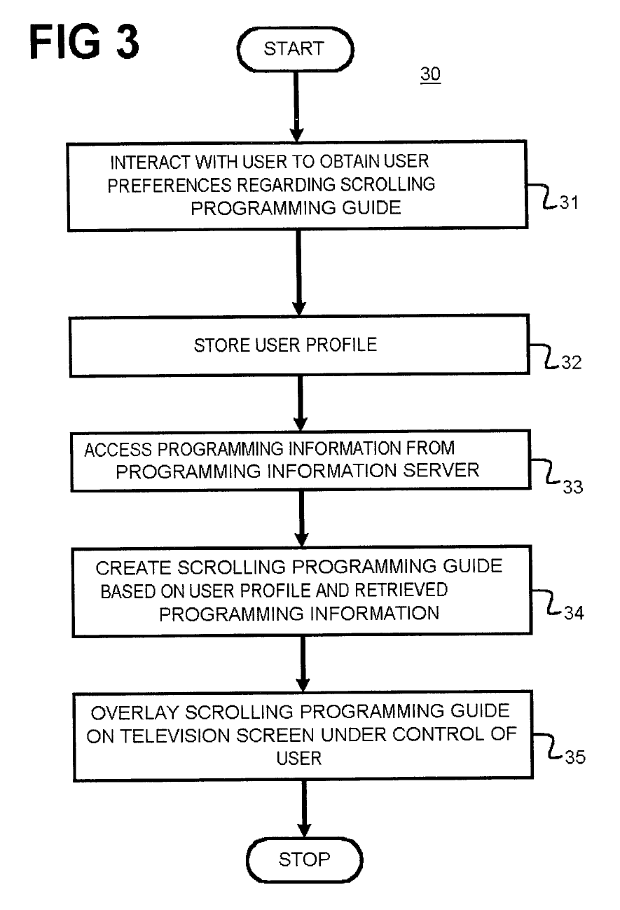

Turning to FIG. 3, shown therein is a flowchart of an exemplary embodiment of a method for creating a scrolling programming guide. The set-top box includes a graphical user interface via which the set-top box obtains the user preferences regarding the scrolling programming guide (step 31). These preferences include inter alia channels to include, categories of programming to display, favorite channels, blocked channels, scrolling speed, scrolling size, text font, text color, personal alerts to be included, and scrolling location.

Once a user establishes these parameters, these parameters are then stored in the set-top box in a file associated with the particular user (step 32). So, different users could store their own scrolling programming guide profiles.

On a predetermined schedule, or as required by user display of the scrolling programming guide, the set-top box accesses a programming information server, which in turn accesses a programming guide database that stores programming information for all programming available (step 33). This information is then formatted and sent to the settop box for use in creating the scrolling ticker.

The scrolling ticker is then created by filtering the programming information using the user profile selected by a given user (step 34). For example, the programming information for the channels that the user selected is placed on a single line of text running end-to-end with an appropriate delimiter indicating the start and stop of each channel. Other parameters set by the user are then used to determine the size, location, format and speed of the scrolling programming information ticker. The programming information ticker is then overlaid on the television image and activated under control of the user (step 35).

Although various embodiments are specifically illustrated and described herein, it should be noted that modifications and variations of the invention are covered by the above teachings and are within the purview of the appended claims without departing from the spirit and intended scope of the invention. Furthermore, these examples should not be interpreted to limit the modifications and variations of the invention covered by the claims but are merely illustrative of possible variations.

What is claimed is:

1. A method for providing programming information available on a broadcast television service comprising:
interacting with a user to obtain user preferences regarding a scrolling programming guide;
storing the user preferences as a user profile in a set-top box that is coupled to a television display;
accessing a programming information server over a communication link between the set-top box and the programming information server to obtain programming information;
creating a scrolling programming guide based on the stored user profile; and
overlaying the scrolling programming guide on the television screen when activated by the user.

2. The method according to claim 1, wherein the user preferences include a plurality of channels to include in the scrolling programming guide.

3. The method according to claim 1, wherein the user preferences include a one or more categories of programming to display in the scrolling programming guide.

4. The method according to claim 1, wherein the user preferences include a scrolling speed of the scrolling programming guide.

5. The method according to claim 1, wherein the user preferences include a scrolling size of the scrolling programming guide.

6. The method according to claim 1, wherein the user preferences include a scrolling location of the scrolling programming guide.

7. The method according to claim 6, wherein the scrolling location includes one of the following: a lower horizontal section of the display, an upper horizontal section of the display, a right vertical section of the display, and a left vertical section of the display.

9. The method according to claim 1, wherein the user preferences include a format of the scrolling programming guide.

10. The method according to claim 1, wherein the user preferences include whether one or more personal alerts are included in the scrolling programming guide.

11. The method according to claim 1, wherein the user preferences include an amount of current and future programming to be included in the scrolling programming guide.

12. The method according to claim 1, further comprising including textual advertising in the scrolling programming guide.

13. The method according to claim 1, further comprising obtaining user preferences for a plurality of users and storing the preferences for each of the users under a unique identifier so each user can activate the scrolling programming guide with said each user's preferences.

14. An apparatus for providing programming information to a user regarding a television broadcast service comprising:
a set-top box including a processor, memory and a graphical user interface to interact with the user to obtain a user profile regarding user preferences for a scrolling programming guide, said processor storing the user profile in the memory;
a display displaying programming to the user and displaying a scrolling programming guide when activated by user interaction with the set-top box, wherein said processor in said set-top box creates the scrolling programming guide based on the stored user profile.

15. The apparatus according to claim 14, further comprising a database storing programming information on all channels included in the television broadcast service.

16. The apparatus according to claim 14, further comprising a server coupled to the set-top box and the database and providing programming information to the set-top box.

17. The apparatus according to claim 14, wherein the user preferences include a plurality of channels to include in the scrolling programming guide.

18. The apparatus according to claim 14, wherein the user preferences include a one or more categories of programming to display in the scrolling programming guide.

19. The apparatus according to claim 14, wherein the user preferences include a scrolling speed of the scrolling programming guide.

20. The apparatus according to claim 14, wherein the user preferences include a scrolling size of the scrolling programming guide.

21. The apparatus according to claim 14, wherein the user preferences include a scrolling location of the scrolling programming guide.

22. The apparatus according to claim 21, wherein the scrolling location includes one of the following: a lower horizontal section of the display, an upper horizontal section of the display, a right vertical section of the display, and a left vertical section of the display.

23. The apparatus according to claim 14, wherein the user preferences include a format of the scrolling programming guide.

24. The apparatus according to claim 14, wherein the user preferences include whether one or more personal alerts are included in the scrolling programming guide.

25. The apparatus according to claim 14, wherein the user preferences include an amount of current and future programming to be included in the scrolling programming guide.

26. The apparatus according to claim 14, wherein the scrolling programming guide includes textual advertising.

27. The apparatus according to claim 14, wherein the processor and graphical user interface in the set-top box obtains user preferences for a plurality of users and stores the preferences for each of the users under a unique identifier so each user can activate the scrolling programming guide with said each user's preferences.

28. A method for providing programming information available on a television service comprising:
creating a scrolling programming guide based on a stored user profile; and
overlaying the scrolling programming guide on the television screen under activation by the user.

29. The method according to claim 28, further comprising interacting with a user to obtain user preferences regarding the scrolling programming guide.

30. The method according to claim 29, further comprising storing the user preferences as a user profile in a set-top box that is coupled to a television display.

31. The method according to claim 30, further comprising accessing a programming information server over a communication link between the set-top box and the programming information server to obtain programming information.
